(19) United States
(12) Patent Application Publication
(10) Pub. No.: US 2026/0127750 A1
(43) Pub. Date: May 7, 2026

(54) STRUCTURE FROM MOTION ENHANCEMENTS USING GENERALIZED CAMERA MODEL AND MOTION PARAMETRIZATION

(71) Applicant: QUALCOMM Incorporated, San Diego, CA (US)

(72) Inventors: Andrea Porfiri Dal Cin, Amsterdam (NL); Georgi Dikov, Amsterdam (NL); Jihong Ju, Amsterdam (NL); Mohsen Ghafoorian, Diemen (NL)

(21) Appl. No.: 19/285,974

(22) Filed: Jul. 30, 2025

Related U.S. Application Data
(60) Provisional application No. 63/717,689, filed on Nov. 7, 2024.

(51) Int. Cl. G06T 7/246; G06T 7/73

(52) U.S. Cl. CPC G06T 7/251; G06T 7/75; G06T 2207/10016; G06T 2207/20081; G06T 2207/20084; G06T 2207/30241

(57) ABSTRACT

This disclosure provides systems, methods, and devices that utilize machine learning models to determine corresponding spatial positions and motion trajectories for images. In one aspect, a method is provided that includes receiving an image of a scene captured by a camera; determining, with a first machine learning model, a plurality of position values relative to the camera for at least a subset of pixels within the image; and training a second machine learning model based on the determined position values. The method further includes determining basis trajectories based on movement of the positions relative to previous image frames, and determining, for each of a subset of pixels, a movement trajectory relative to the previous frames as a weighted combination of the basis trajectories. These techniques can be employed as part of a structure-from-motion pipeline to estimate multi-view three-dimensional geometry, camera poses, and per-pixel object motion. Additional aspects are provided.

### CROSS-REFERENCE TO RELATED APPLICATIONS

This application claims the benefit of U.S. Provisional Application No. 63/717,689, entitled, “STRUCTURE FROM MOTION ENHANCEMENTS USING GENERALIZED CAMERA MODEL AND MOTION PARAMETRIZATION” filed on Nov. 7, 2024, which is expressly incorporated by reference herein in its entirety.

### TECHNICAL FIELD

Aspects of the present disclosure relate generally to machine learning techniques, and more particularly, to methods and systems suitable for structure from motion techniques.

### INTRODUCTION

Machine learning techniques encompass a diverse array of computational methodologies designed to enable systems to learn from and make predictions or decisions based on data. These techniques typically involve the construction of models, algorithms, or neural network architectures that can infer patterns, trends, or structures within large datasets without explicit programming for each task. Machine learning techniques include supervised learning, where models are trained using labeled datasets; unsupervised learning, which involves the identification of patterns in unlabeled data; semi-supervised learning, which combines both labeled and unlabeled data; and reinforcement learning, where models learn optimal behaviors through trial and error interactions with an environment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One embodiment provides a method that includes receiving an image of a scene captured by a camera; determining, with a first machine learning model, a plurality of position values relative to the camera for at least a first subset of pixels within the image; and training a second machine learning model based on the determined position values.

Another embodiment provides a system that includes a processor and a memory storing instructions which, when executed by the processor, cause the processor to perform operations including receiving an image of a scene captured by a camera; determining, with a first machine learning model, a plurality of position values relative to the camera for at least a first subset of pixels within the image; and training a second machine learning model based on the determined position values.

An additional embodiment provides a non-transitory computer-readable medium storing instructions which, when executed by a processor, cause the processor to perform operations including receiving an image of a scene captured by a camera; determining, with a first machine learning model, a plurality of position values relative to the camera for at least a first subset of pixels within the image; and training a second machine learning model based on the determined position values.

A further embodiment provides a method that includes receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

Another embodiment provides a system that includes a processor and a memory storing instructions which, when executed by the processor, cause the processor to perform operations including: receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

An additional embodiment provides a non-transitory computer-readable medium storing instructions which, when executed by a processor, cause the processor to perform operations that include receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example image processing configuration for a vehicle according to one or more aspects of the disclosure.

FIG. 2 is a block diagram illustrating details of an example wireless communication system according to one or more aspects.

FIG. 3 is a block diagram illustrating a system for determining generalized camera models according to one or more aspects of the disclosure.

FIG. 4 is a block diagram illustrating a system for determining parametrized motion representations according to one or more aspects of the disclosure.

FIG. 5 depicts a schematic diagram of a training process according to one aspect of the present disclosure.

FIG. 6 is a flow chart illustrating an example method for determining generalized camera models according to one or more aspects of the present disclosure.

FIG. 7 is a flow chart illustrating an example method for determining parametrized motion representations according to one or more aspects of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Traditional learning-based Structure-from-Motion (SfM) techniques may typically assume specific types of cameras (such as pinhole camera models) with known intrinsic parameters and undistorted images. These techniques may therefore rely on predefined projection functions tied to specific mathematical camera models, such as a pinhole model with fixed intrinsics. While this simplifies computations, it significantly limits the flexibility and applicability of SfM techniques to real-world scenarios.

In practice, many devices, especially those used in virtual reality (VR) and augmented reality (AR) applications, utilize cameras with wide fields of view that introduce significant distortions (such as radial and tangential distortions). Existing techniques can struggle to handle these distortions due to their reliance on linear camera models and undistorted imagery. High-order polynomial camera models that could represent such distortions often lack closed-form solutions for projection, making them computationally inefficient and unsuitable for integration into differentiable learning frameworks.

As a result, failing to account for these distortions leads to inconsistent 3D reconstructions and inaccurate camera pose estimates. This reduces the applicability of SfM techniques on devices with wide-angle or fisheye lenses, reducing the quality and applicability of 3D mapping and pose estimation in many practical applications.

One solution to this problem is to introduce a general differentiable camera model that does not depend on predefined projection and unprojection equations tied to specific camera models. These techniques can utilize a neural network, such as a multilayer perceptron (MLP), to learn the projection function that maps image coordinates to the directions of incoming light rays in 3D space, which may also be referred to as the “unprojection function.”

By modeling the unprojection function in a flexible and differentiable manner, these techniques can accommodate a wide range of distortions, including radial and tangential distortions found in fisheye and wide-angle lenses. The MLP learns this mapping by being trained on image coordinates expressed in polar form and their corresponding light ray directions, allowing the MLP to generalize across various distortion types.

In certain implementations, the neural network may be invertible (such as an invertible MLP). In such instances, the projection function can be determined by inverting the MLP. In further implementations, to compute the projection function from 3D points to image pixels, a lookup table may be constructed by querying the MLP with sampled image points to generate position values (such as direction vectors). This lookup table enables an approximated projection function, which can be refined using a coarse-to-fine strategy. Initially, a coarse lookup table provides a rough projection estimate, and then finer lookup tables are generated near the projected point to iteratively improve accuracy. This approach maintains computational efficiency while handling complex distortions.

In some aspects, the present disclosure provides techniques for structure from motion techniques that handle camera distortions without relying on specific camera models, which may be particularly beneficial in applications using wide-angle or fisheye cameras. For example, by employing a general differentiable camera model learned through a machine learning model, these techniques can adapt to various types of distortions without prior calibration.

This flexibility enhances the applicability of SfM algorithms across different devices and camera configurations, reducing the need for manual or offline calibration processes. It may improve the user experience by enabling more accurate 3D reconstructions and camera pose estimations, leading to better performance in applications like 3D mapping, navigation, and augmented reality overlays.

Additionally, integrating the general camera model into an end-to-end differentiable SfM pipeline may improve computational efficiency by avoiding iterative distortion correction methods that are computationally intensive and may not guarantee convergence. This can result in faster processing times and reduced computational overhead, which is crucial for real-time applications on devices with limited resources.

Additionally, when imaging scenes contain dynamic elements such as moving people, animals, or objects, standard Structure-from-Motion (SfM) methods can face significant challenges. These methods typically assume static scenes where multi-view geometric constraints are satisfied. Moving objects can violate these constraints, resulting in incomplete or inaccurate 3D reconstructions, misaligned camera poses, and conflicts in camera calibration.

Existing techniques often require known camera poses and intrinsic parameters to handle motion in scenes. Existing techniques may therefore fail to support images with distortions, limiting their applicability in real-world scenarios. Additionally, motion estimation and camera calibration can conflict because inconsistent multi-view measurements might be attributed to either inaccurate calibration or to motion in the scene. This ambiguity makes it difficult to disentangle these factors and achieve accurate reconstructions when both camera parameters and object motions are unknown.

One solution to this problem is to introduce a continuous, low-dimensional representation of motion within a learning-based SfM framework. These techniques model motion using a set of shared basis trajectories that represent simple rigid body motions, such as rotations and translations. Each 3D point's motion is represented as a weighted combination of these basis trajectories.

In particular, a machine learning model may be configured to predict per-pixel weights for the basis trajectories, taking as input the 3D coordinates of points and the time step. This may allow for motion representations that are continuous and adaptable over time, enabling points to change motion trajectories dynamically. By integrating this motion parameterization into the SfM pipeline, the techniques can jointly estimate the 3D geometry, camera poses, intrinsic parameters, and per-pixel object motion, even in the presence of significant scene dynamics.

In some aspects, the present disclosure provides techniques for modeling motion in dynamic scenes within learning-based Structure-from-Motion, which may be particularly beneficial in applications involving scenes with moving objects, such as VR and AR environments. For example, by introducing a low-dimensional motion parameterization using shared basis trajectories and per-pixel weights predicted by an MLP, these techniques can accurately capture object motion without requiring known camera poses or intrinsic parameters.

This may improve the accuracy of camera pose estimation and calibration in scenes dominated by motion, enhancing the robustness of SfM algorithms in real-world scenarios. It allows for the reconstruction of moving objects alongside the static environment, enabling coherent 3D scene reconstruction for applications like 3D object insertion, obstacle avoidance, human and animal detection, AR/VR functionalities, and the like.

Moreover, by jointly modeling motion and camera parameters within the SfM framework, these techniques reduce the likelihood that motion is erroneously attributed to calibration errors. This holistic approach may lead to better performance in dynamic environments and improve the user experience by providing more accurate and consistent 3D reconstructions, which are crucial for immersive and interactive applications.

Additional exemplary aspects of the present disclosure are described below. Contrary to existing differentiable Structure-from-Motion methods, the present techniques may support common distortions in the video frames, such as radial and tangential distortions. This may be achieved by not modelling the camera assuming a predefined camera model, e.g., the pinhole camera model with intrinsics K and fixed unprojection and projection functions. Instead, the present techniques introduce a general camera model that is not tied to a specific mathematical camera model and implements differentiable unprojection and projection functions that allow to fine-tune the MDE network end-to-end on the input sequence, i.e., without restricting the advantages of existing methods that adopt a fixed camera model. The advantage of the general camera model is that it can support a plethora of camera distortions without incurring in the common limitations of mathematical camera models used to support distortions. Specifically, camera models with high representational capabilities have projection functions that are high-order polynomials, such as the Kannala-Brandt model. These camera models may not have closed-form solutions to take a 2D image point into 3D by unprojection, as the radial distortion needs to be removed first using iterative algorithms, such as the fixed-point algorithm, which may have the following disadvantages: (i) convergence is not guaranteed, especially for image points at the image border and with large image distortions, (ii) computationally inefficient as it often requires tens of iterations to remove the distortion from image coordinates, (iii) vanishing gradient problems, as the undistortion steps get progressively smaller as they approach the undistorted coordinates, introducing significant floating point approximations in a learning-based context that negatively affect network training. Overall, modelling the camera as a fixed, high-representational high-order camera model brings many disadvantages that push for the introduction of an alternative approach. Accordingly, the present techniques introduce a flexible differentiable camera model which can seamlessly support radial and tangential distortions, which are the usual kinds of distortions that are usually found in fisheye and wide-angle cameras. This camera model may be used as a plug-in replacement in differentiable Structure-from-Motion pipelines. It streamlines the architecture and set up for the estimation of internal camera parameters without affecting accuracy and generality of the method, including support for the common pinhole model.

In certain existing implementations, only the depth network is optimized, and intrinsics are computed using a weighted interpolation of candidate focal lengths where weights are computed using a softmin of the reprojection losses obtained using each of the focal length candidates. Such implementations may work well for pinhole cameras, especially if one may assume a reasonable range of candidate focal lengths. However, the accuracy of the estimated intrinsics depends on the number of candidate focal lengths. Adding candidates results in higher computational and memory requirements because Procrustes alignment and loss computation must be performed separately for each candidate. Additionally, these implementations do not scale effectively when adding more parameters for distortion correction. Furthermore, camera models such as the EUCM and DSCM are ambiguous, in the sense that multiple sets of parameters may represent the same physical camera sensor. Accordingly, weighted interpolation may not work with these techniques, as an arbitrary number of parameter sets may yield low errors and thus high weights in the interpolation, hindering convergence of the network to a single global minimum. By having a camera model that is general and non-ambiguous, these limitations can be overcome.

In particular, the present techniques may include (1) a differentiable flexible camera model, (2) an SfM pipeline that makes use of this camera model, and (3) motion handling for dynamic scenes when using this parameterization of camera. The proposed projection and unprojection functions may be differentiable, with the goal of embedding these into learning-based Structure-from-Motion that would benefit from end-to-end fine-tuning on the input video.

The general camera model may map each image point to the direction of the incoming light ray without using a predefined unprojection function and may thus be capable of supporting radial and tangential lens distortion. First, the unprojection π⁻¹ and projection π are defined, and optimizations for radially symmetric cameras and for efficient computation of π are discussed.

Unprojection. Consider an image point x=(ρ, θ) in the domain of polar coordinates Ω, where ρ is the radial distance, and θ the azimuthal angle. The unprojection function π⁻¹: Ω→S² maps each image point x∈Ω, to the direction of the incoming light ray s=(ψ, φ) on the unit sphere S².

Projection. Consider a 3D point X=(r, ψ, φ)∈R⁺×S² in spherical coordinates, where r is the radius. The projection function π: R⁺×S²→Ω maps a 3D point to its projection x∈Ω on the image plane.

In certain implementations, the unprojection function π⁻¹ may be learned using an invertible multi-layer perceptron (MLP), henceforth termed camera network, which enables consistent computation of the projection function π, such that x=π(π⁻¹(x)) for all x∈Ω.

In other implementations, the projection 7 may not be computed or learned directly, rather it may be computed from a lookup table consisting of entries derived from π⁻¹, as follows. This lookup table may be constructed using direction vectors {sᵢ∈S²} as keys and their corresponding image points as values {xᵢ∈Ω}. Specifically, the key-value pairs are generated by uniformly sampling pivot image points xi across the image plane and computing their unprojected direction using sᵢ=π⁻¹(xᵢ). The resulting pairs sᵢ→xᵢ form the lookup table used to approximate the projection function 71.

To project X onto the image plane, its direction s=(ψ,θ) is considered. Since the lookup table only comprises discrete samples of direction vectors {sᵢ∈S²}, an exact match for s may not be available. To estimate the projection x=π(X), it may be interpolated between keys. First, interpolation weights wᵢ are determined based on the cosine similarity between the query direction vector s and each key sᵢ using a softmax function:

$${ω}_{i} = \frac{exp ( \frac{s \cdot {s}_{i}}{t} )}{{\sum }_{k} exp ( \frac{s \cdot {s}_{k}}{t} )} ,$$

where t is the hyperparameter controlling the smoothness of the interpolation. Then, the projected image coordinate x is computed differentiably as a weighted sum of all pivot image points {xᵢ} in the lookup table: x=Σₓᵢ wᵢxᵢ.

Optimization: Coarse-to-Fine Projection. Since π is computed approximately from π⁻¹, it is desirable to minimize the projection error ϵ=x−π(π⁻¹(x)) given an image point x∈Ω. This can be achieved by increasing the sampling frequency of pivot points {xᵢ}, but at the cost of increased memory consumption due to the larger lookup table.

ϵ may be reduced without affecting the computational efficiency of π by introducing coarse-to-fine refinement of π. Given an initial projection x=π(X), we consider a square neighborhood N(x) centered at x and extending ±δ along both image axes, where δ is defined as the minimum distance between the sampled pivot points {xᵢ}. Then, pivot points are sampled {x₁} at equal distance in N(x), and compute weights w₁ as shown above. The refined projection x′=ΣX_{lϵN}(ₓ) wₗxₗ may be computed, summing over all pivot points {x₁} in N(x).

The coarse-to-fine refinement can be repeated, each time focusing on a smaller neighborhood to refine the projected coordinates. In certain implementations, such coarse-to-fine refinement can help achieving a lower projection error e compared to other solutions, such as having an invertible MLP learning π⁻¹ from which π can be computed.

Having introduced the general camera model, a learning-based Structure-from-Motion solution (referred to as AnyMap) is provided that is designed for distorted videos and making use of the proposed camera model.

Structure-from-Motion. The input is a video sequence of V frames {Iᵢ∈R^{H×W×3}} captured by a camera with constant intrinsic parameters. The goal is to estimate per-pixel depth maps {Dᵢ∈R^{H×W}} and world-to-camera extrinsics Eᵢ∈SE(3). Optionally, a camera model m may be provided to estimate camera intrinsic matrix K∈R^{3×3} and a set k={k₁, . . . , kₙ} of coefficients for m.

From a high-level perspective, depths may be parametrized as a neural network mapping each Iᵢ to its corresponding depth map Dᵢ. The network is fine-tuned on the input video using supervision from pixel-wise correspondences between frame pairs, computed via optical flow or long-range 2D tracks obtained from off-the-shelf methods. Specifically, the estimated depths, camera poses, and camera representation collectively induce an optical flow between any two frames, which are computed differentiably. By supervising the induced flow by the externally computed optical flow and tracks, AnyMap learns consistent multi-view 3D geometry, camera extrinsics as well as the unprojection function π⁻¹ for the general camera model Sec. 3.1. This implicit representation is essential for the unprojection and projection of image points and 3D points, respectively, during the computation of the induced per-pixel flow between arbitrary frame pairs.

AnyMap may parameterize of depth, camera pose, and internal representations.

Depth Estimation. Depth is parameterized by a neural network that maps each frame Iᵢ to a per-pixel depth map Dᵢ. This approach encourages similar depths to be predicted for similar image patches across the video, allowing updates to the network weights from one frame to propagate to analogous regions in other frames. Consequently, high-quality depth estimates are achieved even when the input optical flow or point tracks are inaccurate for some frames, or when dealing with small inter-frame baselines or degenerate motions (e.g., purely rotational motion). Since camera calibration is known to be challenging in the presence of degenerate motions, this parameterization is particularly effective for AnyMap.

Camera Intrinsics. Unlike existing learning-based and traditional Structure-from-Motion (SfM) approaches, the present techniques do not rely on fixed projection and unprojection equations to model the camera. Instead, the techniques employ the general camera model introduced above to unproject depths into 3D camera coordinates. Specifically, the unprojected 3D point Xᵢ(c) (u) corresponding to image point u in frame i is given by:

$${x}_{i}^{( c )} ( u ) = {( z tan ( ψ ) cos ( ϕ ) z tan ( ψ ) cos ( ϕ ) z )}^{T} ,$$

where z=Dᵢ(u) is the predicted depth at u, and (ψ, φ))=π−1(u). Note that the unprojection is undefined for ψ=±90°, corresponding to a maximum field of view of 180°.

The unprojection function π⁻¹ is modeled using a multilayer perceptron (MLP) that takes as input the polar coordinates u=(ρ, θ) of an image point and outputs a two-dimensional vector s=(ψ, φ), representing the direction of the light ray projecting onto u, as defined above. If the camera capturing the video is radially symmetric, the optimizations discussed above may be utilized to reduce the MLP's input and output dimensions, resulting in a one-dimensional mapping ρ→ψ.

Since the camera intrinsics remain constant throughout the video, π⁻¹(u) may be computed only once for each pixel and reuse these values across all frames, updating π⁻¹ only when the weights of the MLP change.

Camera Extrinsics. The relative camera poses are estimated using a differentiable solution for the relative pose that best aligns consecutive pairs of unprojected depth maps.

Depth map alignment may be formulated as an orthogonal Procrustes problem, which has a closed-form, differentiable solution.

Consider two frames i and j. Their depth maps Dᵢ and Dⱼ may be unprojected using the learned unprojection function π¹ to obtain two point clouds Xᵢ^{(c)} and Xⱼ^{(c)} in camera coordinates. Given known correspondences between frames i and j, matched point sets X^{↔}ᵢⱼ and X^{↔}ⱼᵢ with one-to-one correspondences may be extracted. The Procrustes problem seeks the rigid transformation Eᵢⱼ that minimizes the weighted sum of squared distances between the matched points:

$${E}_{i j} = \begin{matrix}arg min \\ E\end{matrix} ‖ {W}^{\frac{1}{2}} ( {X}_{j i}^{↔} - E {X}_{i j}^{↔} ) ‖ ,$$

where W contains correspondence weights that can down-weight correspondences. We adopt the MLP-based solution to predict W from per-pixel features extracted by the encoder of the depth network.

Without loss of generality, the first frame I₁ may be fixed to have the identity pose, i.e., E₁=I₄.

Estimating intrinsics for an input model. Although the present techniques do not directly estimate the camera intrinsics K and distortion coefficients k for a specific camera model, the learned unprojection function π⁻¹ parameterized by the MLP can be fitted to a provided camera model m to obtain optimal intrinsics \hat{ }K and distortion coefficients \hat{ }k that best describe the learned unprojection π⁻¹ according to the unprojection equations Ψ⁻¹ of m. Practically, the following objective function can be minimized:

$$\hat{K} , \hat{k} = \begin{matrix}arg min \\ K , k\end{matrix} \begin{matrix}\sum \\ x ∈ Ω\end{matrix} a ( {‖ {π}^{- 1} ( x ) - {Ψ}^{- 1} ( x , K , k ‖}_{2} ) ,$$

where a is a robust loss function (e.g., Huber loss), and \hat{ } is the unprojection equations for the camera model m with parameters K and k.

Motion Handling. In the presence of moving objects in the scene, the correspondence \hat{x}_{i→j} of an image point x between arbitrary frame pairs i, j induced by the estimated depths, extrinsics and intrinsics will not be geometrically consistent between the static and moving part of the scene, due to the moving objects not satisfying the same epipolar constraints that apply to the static background. This has a detrimental effect on the optimization of AnyMap for dynamic scenes, which relies on observed correspondences \hat{x}_{i→j} from e.g. optical flow or point tracks is based on the estimated correspondences to fine-tune the network on the input video sequence. Without addressing motion in the scene, the inconsistency in epipolar geometry manifests in inaccurate depth estimation for the moving parts of the scene, which are reconstructed at their own arbitrary scale, and also inaccurate camera calibration at image regions of moving objects.

For this reason, the present techniques may explicitly estimate motion in the scene to avoid the negative effects that moving objects have on depth estimation and camera calibration.

Motion Parameterization. Motion may be modeled in the scene using a low-dimensional representation of 3D motion trajectories. At each time step i, a set of B basis trajectories {Tᵢ^{(b)}}_{b=1}^{B} are learned, where each Tᵢ^{(b)} is a roto-translation in the special Euclidean group SE(3). These basis trajectories are globally shared among all 3D points in the scene, defining common motion components in the scene.

For any image point x, the point is first unprojected at time i to obtain its 3D world coordinates Xᵢ(x). The motion of point x from frame i to its consecutive i+1 is represented by the transformation Tᵢ₊₁ (x), computed as a weighted combination of the basis trajectories:

$${T}_{i} = \begin{matrix}\begin{matrix}B \\ \sum \end{matrix} \\ b = 1\end{matrix} {w}_{i}^{( b )} ( x ) {T}_{i}^{( b )} ,$$

where the scalar weights wᵢ^{(b)} (x) satisfy ∥wᵢ^{(b)} (x)∥=1, with wi (x)=(wᵢ⁽¹⁾ (x), . . . , wᵢ^{(B)} (x)).

These weights may be predicted by a multi-layer perceptron (MLP)g, which maps the 3D world coordinates Xᵢ(x) and the time step i to the weight vector:

$${w}_{i}^{( b )} ( x ) = 𝒢 ( {X}_{i} ( x ) , i )$$

Including the time step i as an input allows the MLP to adapt the weights over time, enabling the assignment of points to motion trajectories to change dynamically.

To compute the cumulative transformation T_{i→j} over multiple frames where j−i>1, the present techniques may iteratively apply the per-frame motion transformations to the 3D point Xi(x). At each subsequent time step k (where k=i, i+1, . . . , j−1), the point's position may be updated using:

$${X}_{k + 1} ( x ) = {T}_{k} ( x ) {X}_{k} ( x ) ,$$

where Tₖ (x) is computed according to (5). By recursively applying (7), the 3D position Xⱼ (x) of point x at frame j becomes:

$${X}_{j} ( x ) = ( {\prod }_{k = i}^{j - 1} {T}_{k} ( x ) ) = {T}_{i \to j} {X}_{i} ( x ) ,$$

where the product denotes the sequential application of transformations from frame i to frame j−1.

Losses. The optimization of ANYMAP is driven by the loss L, which consists in a weighted linear combination of the reprojection loss L^{2D}, motion-weighted ordinal depth loss L^{depth}, and loss on the unprojected light rays, where λ₁ and λ₂ are hyperparameters. These loss terms may be defined as provided below.

Reprojection loss. Consider an image point x in frame i. We unproject x into 3D world coordinates Xᵢ (x) using the estimated depth Di, extrinsics Ei, and the unprojection π⁻¹. Next, the cumulative motion transformation T_{i→j} may be applied to Xᵢ(x) to obtain its position at frame j:

$${X}_{j} ( x ) = {T}_{i \to j} ( {X}_{i} ( x ) , i ) {X}_{i} ( x ) ,$$

where T_{i→j}(Xᵢ(x), i) represents the motion from frame i to frame j for point Xᵢ(x). In static scenes, this transformation simplifies to the identity matrix T_{i→j}=I₄.

Xⱼ(x) may then be projected onto the image plane of frame j using the extrinsics Eⱼ and the projection π:

$${\hat{x}}_{i \to j} = π ( {E}_{J}^{- 1} {X}_{J} ( x ) ) ,$$

which yields the predicted image point x_{i→j} in frame j corresponding to the original point x in frame i. Given known correspondences x_{i→j} between frames—obtained from methods like optical flow or long-range 2D tracking—we define the reprojection loss L2D as:

$${ℒ}_{i \to j}^{2 D} = \sum ‖ {\hat{x}}_{i \to j} - {x}_{i \to j} ‖$$

where the sum is over all considered points x in frame i.

This loss function measures the discrepancy between the predicted correspondences xi\hat{ }j and the actual observed correspondences xi\hat{ }j, encouraging the estimated motion transformations and camera parameters to align with the observed data.

Weighted ordinal depth loss. The introduction of the rigid transformation T_{i→j} may allow the optimization to increase T_{i→j} where L^{2D} cannot be minimized effectively. Thus, the transformation T_{i→j} becomes a measure of how much of an outlier the estimated 2D correspondence x_{i→j} is with respect to the observed x_{i→j}. As such, without constraining the predicted depths, L2D does not penalize inaccurate depth estimates where T_{i→j} is high. For this reason, where T_{i→j} is large and the reprojection loss is unreliable, monocular depth estimation may be used, with the goal of having moving objects scaled consistently with respect to the static background. Specifically, to constrain the predicted depth Dᵢ at each time frame i to the monocular depth estimates Dᵢ using an ordinal loss function with a penalization term if two depth maps have depths that are incorrectly ordered at the same sampled pair of pixel locations. In other words, the ordinal depth loss enforces that two depth maps are related by a linear transformation, promoting consistency between the two.

A movement-weighted version of the ordinal loss may be used as a depth prior loss to ensure that this consistency is enforced for image points with high predicted motion. Consider two sampled pixel locations x1 and x₂, then the magnitude of motion of pixel x₁ from i→j is M_{i→j}(xᵢ)=∥Xⱼ(x₁)−Xᵢ(x₁)∥₂ and the weighted ordinal loss for two sampled pixels x₁ and x₂ is computed as follows:

$${ℒ}^{depth} ( {x}_{1} , {x}_{2} ) = {M}_{i \to k} ( {x}_{1} ) ‖ tanh ( α ( D ( {x}_{1} ) - D ( {x}_{1} ) ) ) - R ( D ( {x}_{2} ) ) ‖$$

where R is the order indicator function on depth map D which indicates the order between the depth values of x₁∈ and x₂∈ and D(x) means the depth value of pixel x.

Rays loss. As some image regions, especially at image borders may not provide reliable correspondences due to the limited number of pixels involved, we introduce a loss function that penalizes the predicted viewing rays from drifting significantly from a mathematical camera model. This ensures that the model is still general and can be fine-tuned to the input video sequence, while avoiding it to diverge at certain image locations due to faulty correspondences between frames.

Considering the camera model m, the objective function may be minimized to estimate K, k. Then, the rays loss is defined as:

$${ℒ}^{rays} = {\sum }_{x ∈ Ω} {‖ {π}^{- 1} ( x ) - {Ψ}^{- 1} ( x , K , k ‖}_{2} ,$$

where Ψ⁻¹ is the unprojection function for m.

### Training.

Initialization Procedure. An initialization step may be performed to obtain initial estimates of the camera distortion parameters. This involves using standard calibration techniques or pre-existing datasets to provide a rough estimate of distortion, which helps in stabilizing the subsequent optimization processes.

After acquiring these initial estimates, an ad-hoc initialization step tailored for motion sequences may be performed. This step promotes choosing the background as the reference coordinate system from which motion is then estimated. Specifically, align the scales of monocular depth maps may be aligned over several iterations, similar to the approach in Casual Structure-from-Motion. This alignment is crucial for ensuring that the depth scales of different frames are consistent, which is a prerequisite for accurate motion estimation.

Once the scales are aligned, the scales may be kept fixed and run additional iterations where both the depths and camera poses are jointly optimized. This joint optimization refines the depth estimates and camera parameters simultaneously, leading to a more accurate reconstruction of the scene geometry and motion.

Optimization. AnyMap may be optimized end-to-end on the input video {Iᵢ}ᵢ₌₁^{V}, fine-tuning the weights of the depth neural network, the MLP modelling n⁻¹, and the MLP predicting the correspondence weights W.

For optical flow correspondences, both the forward and backward flow may be considered. For example, the loss for each i→i±1 may be computed. For long-range tracks, L_{2D}^{i→j} for all (i,j)∈[V]×[V], i≠j may be computed.

Implementation Details. AnyMap is optimized on each input video sequence for up to 10000 epochs using the Adam optimizer. Pre-training from FlowMap may be used to initialize the MLP predicting correspondence weights W and the depth neural network. The depth neural network is MiDAS CNN with 21.3 M trainable parameters. The unprojection MLP is a fully convolutional with 3 layers, with each consisting of 8 neurons with the leaky relu activation function at each layer, except for the last, which does not have an activation function. The MLP is fully convolutional, with the final activation layer being a softmax layer to ensure that the weights form a valid probability distribution over the basis trajectories.

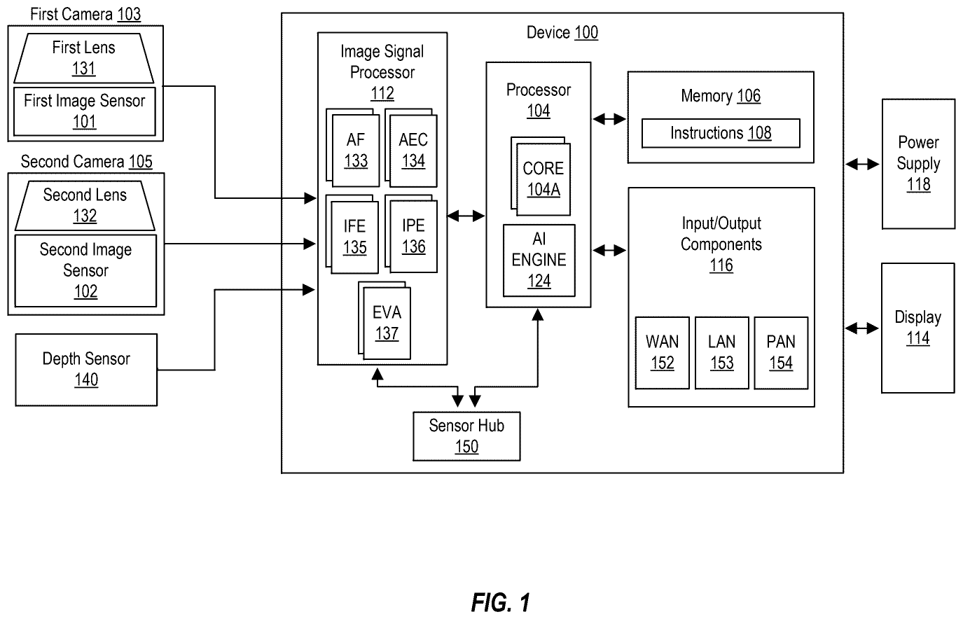

FIG. 1 shows a block diagram of an example processing system 100 according to one or more aspects of the disclosure. The processing system 100 may include, or otherwise be coupled to, an image signal processor 112 for processing image frames from one or more image sensors, such as a first image sensor 101, a second image sensor 102, and a depth sensor 140. In some implementations, the processing system 100 also includes or is coupled to a processor (e.g., CPU) 104 and a memory 106 storing instructions 108. The processing system 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, such as other computing devices, mobile devices, vehicles, and/or a remote monitoring system. The network interfaces may include one or more of a wide area network (WAN) adaptor 152, a local area network (LAN) adaptor 153, and/or a personal area network (PAN) adaptor 154. An example WAN adaptor 152 is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The processing system 100 may further include or be coupled to a power supply 118, such as a mains power supply, a battery, and the like. The processing system 100 may also include or be coupled to additional features or components that are not shown in FIG. 1. In one example, a wireless interface, which may include one or more transceivers and associated baseband processors, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The processing system 100 may include a sensor hub 150 for interfacing with and/or receiving data from sensors (such as non-camera sensors). One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 150 may interface to a vehicle bus for sending configuration commands and/or receiving information from vehicle sensors 172, such as distance (e.g., ranging) sensors or vehicle-to-vehicle (V2V) sensors (e.g., sensors for receiving information from nearby vehicles). Other examples of sensors may include pressure sensors, temperature sensors, light sensors, and the like. In certain implementations, the sensors may be communicatively coupled to the sensor hub 150 through a direct connection (such as a bus connection). In additional or alternative implementations, the sensors may be indirectly coupled to the sensor hub (such as via a network connection).

The image signal processor (ISP) 112 may receive image data, such as used to form image frames. In one embodiment, a local bus connection couples the image signal processor 112 to image sensors 101 and 102 of a first camera 103 and second camera 105, respectively. In another embodiment, a wire interface may couple the image signal processor 112 to an external image sensor. In a further embodiment, a wireless interface may couple the image signal processor 112 to the image sensor 101, 102.

The first camera 103 may include the first image sensor 101 and a corresponding first lens 131. The second camera 105 may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140. In some embodiments, the lenses 131 and 132 may have a fixed focus.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

Each of the cameras 103, 105 may include one, two, or more image sensors 101, 102. For example, the camera 103 may include a first image sensor 101 and a second image sensor (not depicted). When multiple image sensors are present, the first image sensor 101 may have a larger field of view (FOV) than the second image sensor or the first image sensor 101 may have different sensitivity or different dynamic range than the second image sensor. In one example, the first image sensor 101 may be a wide-angle image sensor, and the second image sensor may be a telephoto image sensor. In another example, the first image sensor 101 is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view. Although the example discussed above focused on the first camera 103, the second camera 105 may be configured using one or more of the configurations discussed above (such as with a first image sensor 102 and a second image sensor (not depicted)).

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines (IPEs) 136, and or one or more auto exposure compensation (AEC) 134 engines. The AF 133, AEC 134, IFE 135, IPE 136 may each include application-specific circuitry, be embodied as software code executed by the ISP 112, and/or a combination of hardware within and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed during operation of the processing system 100 for generating images or videos. The instructions 108 may also include other applications or programs executed for the processing system 100, such as an operating system, mapping applications, or entertainment applications. Execution of the camera application, such as by the processor 104, may cause the processing system 100 to generate images using the image sensors 101 and 102 and the image signal processor 112. The memory 106 may also be accessed by the image signal processor 112 to store processed frames or may be accessed by the processor 104 to obtain the processed frames. In some embodiments, the processing system 100 includes a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including object detection, image processing, natural language processing, text generation, risk map generation, driver monitoring, driver alert operations, and the like. For example, execution of the instructions can instruct the image signal processor 112 to begin or end capturing an image frame or a sequence of image frames. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106. In executing the camera application, the processor 104 may be configured to instruct the image signal processor 112 to perform one or more operations with reference to the image sensors 101, 102, as discussed above.

In some embodiments, the processor 104 may include ICs or other hardware (e.g., an artificial intelligence (AI) engine 124) in addition to the ability to execute software to cause the processing system 100 to perform a number of functions or operations, such as the operations described herein. In some other embodiments, the processing system 100 does not include the processor 104, such as when all of the described functionality is configured in the image signal processor 112. In particular embodiments, the processor 104 and/or another processor of the processing system 100 may include a machine learning processor. Machine learning processors may include one or more processing units tailored for operating/manipulating machine learning data/features structures (e.g., tensors), executing machine learning algorithms, or a combination thereof. A first example machine learning processor includes Neural Processors (NPs), hardware components specifically designed to perform calculations necessary for artificial neural networks, leveraging parallel processing capabilities to handle complex computational tasks efficiently. A second example machine learning processor includes Hardware-Based Machine Learning Accelerators (MLAs) that enhance the speed of machine learning applications by optimizing the underlying hardware for specific machine learning algorithms (such as for particular types of computing operations). A third example machine learning processor may include an machine learning (ML) core within a CPU, which may be embedded in a traditional CPU and may be specifically optimized to accelerate machine learning workloads or computations. A fourth example machine learning processor may include Neural Signal Processors (NSPs) and/or Neural Processing Units (NPUs) are other types of processors that are designed for optimized performance with neural network-based workloads.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the processing system 100 is referred to in the examples herein for including aspects of the present disclosure, some device components may not be shown in FIG. 1 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the processing system 100.

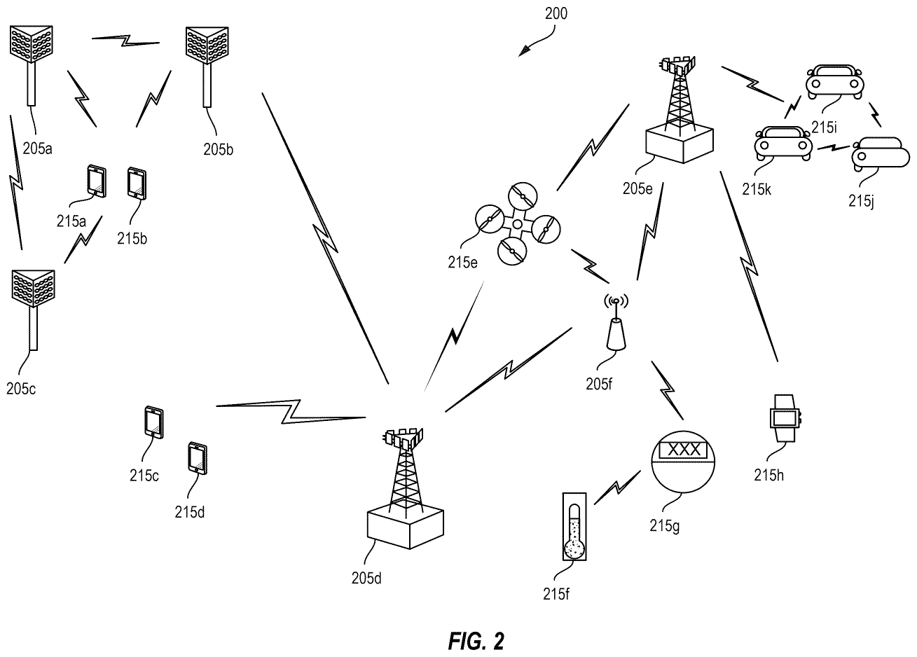

The processing system 100 may communicate as a user equipment (UE) within a wireless network 200, such as through WAN adaptor 152, as shown in FIG. 2. FIG. 2 is a block diagram illustrating details of an example wireless communication system according to one or more aspects. Wireless network 200 may, for example, include a 5G wireless network. As appreciated by those skilled in the art, components appearing in FIG. 2 are likely to have related counterparts in other network arrangements including, for example, cellular-style network arrangements and non-cellular-style-network arrangements (e.g., device-to-device or peer-to-peer or ad-hoc network arrangements, etc.).

Wireless network 200 includes base stations 205 and other network entities. A base station may be a station that communicates with the UEs and may also be referred to as an evolved node B (eNB), a next generation eNB (gNB), an access point, and the like. Each base station 205 may provide communication coverage for a particular geographic area. In 3GPP, the term “cell” may refer to this particular geographic coverage area of a base station or a base station subsystem serving the coverage area, depending on the context in which the term is used. In implementations of wireless network 200 herein, base stations 205 may be associated with a same operator or different operators (e.g., wireless network 200 may include a plurality of operator wireless networks). Additionally, in implementations of wireless network 200 herein, base station 205 may provide wireless communications using one or more of the same frequencies (e.g., one or more frequency bands in licensed spectrum, unlicensed spectrum, or a combination thereof) as a neighboring cell. In some examples, an individual base station 205 or UE 215 may be operated by more than one network operating entity. In some other examples, each base station 205 and UE 215 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 2, base stations 205d and 205e are regular macro base stations, while base stations 205a-205c are macro base stations enabled with one of three-dimension (3D), full dimension (FD), or massive MIMO. Base stations 205a-205c take advantage of their higher dimension MIMO capabilities to exploit 3D beamforming in both elevation and azimuth beamforming to increase coverage and capacity. Base station 205f is a small cell base station which may be a home node or portable access point. A base station may support one or multiple (e.g., two, three, four, and the like) cells.

Wireless network 200 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 215 are dispersed throughout the wireless network 200, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 215, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 215i-k are specifically shown as vehicles, a vehicle may employ the communication configuration described with reference to any of the UEs 215a-215k.

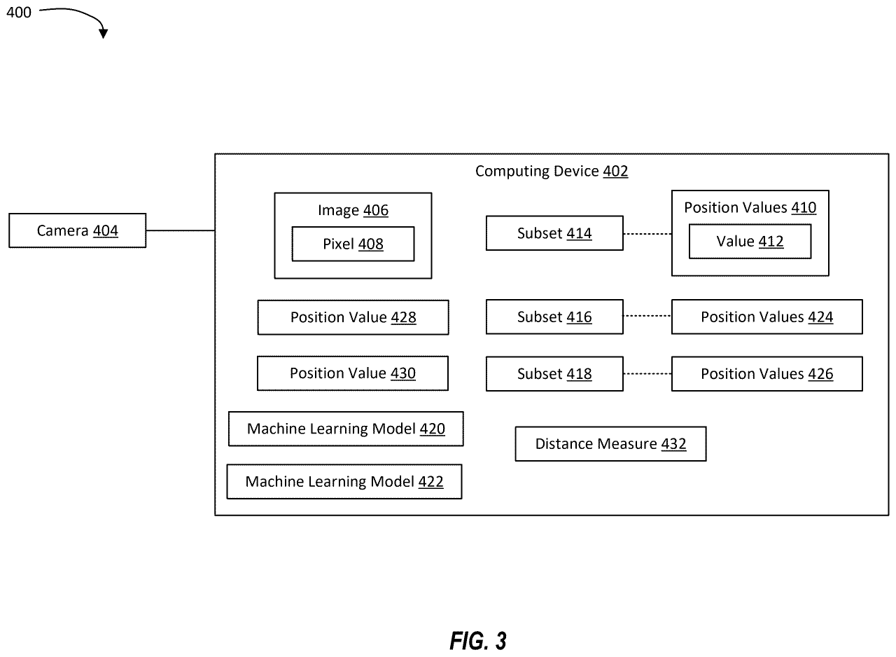

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 215a-215d of the implementation illustrated in FIG. 2 are examples of mobile smart phone-type devices accessing wireless network 200. A UE may also be a machine specifically configured for connected communication, including machine type communication (MTC), enhanced MTC (eMTC), narrowband IoT (NB-IoT) and the like. UEs 215e-215k illustrated in FIG. 3 are examples of various machines configured for communication that access wireless network 200.

A mobile apparatus, such as UEs 215, may be able to communicate with any type of the base stations, whether macro base stations, pico base stations, femto base stations, relays, and the like. In FIG. 2, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 200 may occur using wired or wireless communication links.

In operation at wireless network 200, base stations 205a-205c serve UEs 215a and 215b using 3D beamforming and coordinated spatial techniques, such as coordinated multipoint (CoMP) or multi-connectivity. Macro base station 205d performs backhaul communications with base stations 205a-205c, as well as small cell, base station 205f. Macro base station 205d also transmits multicast services which are subscribed to and received by UEs 215c and 215d. Such multicast services may include mobile television or stream video, or may include other services for providing community information, such as weather emergencies or alerts, such as Amber alerts or gray alerts.

Wireless network 200 of implementations supports mission critical communications with ultra-reliable and redundant links for mission critical devices, such UE 215e, which is a drone. Redundant communication links with UE 215e include from macro base stations 205d and 205e, as well as small cell base station 205f. Other machine type devices, such as UE 215f (thermometer), UE 215g (smart meter), and UE 215h (wearable device) may communicate through wireless network 200 either directly with base stations, such as small cell base station 205f, and macro base station 205e, or in multi-hop configurations by communicating with another user device which relays its information to the network, such as UE 215f communicating temperature measurement information to the smart meter, UE 215g, which is then reported to the network through small cell base station 205f. Wireless network 200 may also provide additional network efficiency through dynamic, low-latency TDD communications or low-latency FDD communications, such as in a vehicle-to-vehicle (V2V) mesh network between UEs 215i-215k communicating with macro base station 205e.

Aspects of the systems described with reference to, and shown in, FIGS. 1 and 2 may include determining a generalized camera model, determining parametrized motion representations, or a combination thereof.

FIG. 3 is a block diagram illustrating a system 400 for determining generalized camera models according to one aspect of the present disclosure. The system 400 may be an exemplary implementation of the processing system 400. As noted above, machine learning processors (such as the machine learning processor 120) may be implemented as one or more of a neural processor, a hardware-based machine learning accelerator, a machine learning core within a CPU, an NSP, an NPU, and the like. The system 400 includes a camera 404 and a computing device 402. The computing device 402 includes an image 406, a plurality of position values 410, a first subset 414, a first machine learning model 420, a first set of position values 424, a second set of position values 426, a second subset 416, a third subset 418, a first position value 428, a second position value 430, a distance measure 432, a second machine learning model 422. The image 406 includes a respective pixel 408 and the plurality of position values 410 includes a respective position value 412.

The computing device 402 may be configured to receive an image 406 of a scene captured by a camera 404. In certain implementations, the computing device 402 may receive the image 406 in real-time from the camera 404 via a wired or wireless communication interface. The image 406 may be in various digital formats such as RAW, JPEG, PNG, or other suitable image file types. The camera 404 may be any type of image-capturing device capable of generating digital images, such as monocular cameras, stereo cameras, fisheye cameras, depth-sensing cameras, cameras with wide-angle lenses, and the like. The camera 404 may be integrated into the computing device 402 or may be an external device connected through interfaces such as USB, HDMI, Wi-Fi, or Bluetooth. In certain implementations, the image 406 may be part of a sequence of images forming a video stream, allowing the computing device 402 to process multiple frames over time for applications such as SfM, motion tracking, or 3D reconstruction.

The computing device 402 may be configured to determine, with a first machine learning model 420, a plurality of position values 410 relative to the camera 404 for at least a first subset 414 of pixels within the image 406. In certain implementations, the plurality of position values 410 may represent three-dimensional spatial information relative to the camera 404 for pixels within the image 406. These position values 410 may include, for example, direction vectors from the camera 404 toward points in the scene, depth values indicating the distance along a viewing direction, coordinates within a three-dimensional space (such as Cartesian, spherical, or cylindrical coordinate systems), or a combination thereof.

In certain implementations, the first machine learning model 420 may be trained to implement a first projection function that maps image 406 coordinates to corresponding position values. In certain implementations, the first projection function may be referred to as an “unprojection function” or “back-projection function,” which maps two-dimensional image coordinates from the image 406 to corresponding position values 410 in three-dimensional space. The first projection function may also be known as the “inverse projection function” or “2D-to-3D mapping function.”

In certain implementations, the first machine learning model 420 may be implemented as a neural network model, which may include a multilayer perceptron (MLP) model. The MLP may consist of multiple fully connected layers (such as with nonlinear activation functions) configured to learn complex nonlinear mappings between input image coordinates and output position values 410. The input to the MLP may include normalized pixel coordinates from the image 406, potentially expressed in polar coordinates for radially symmetric camera models. The output may be the corresponding position values 410, such as direction vectors in spherical coordinates.

The model 420 may be trained using supervised learning, where a dataset of images with known ground truth position values is available. Training may include adjusting the model's weights to minimize a loss function that measures the difference between the predicted position values and the ground truth. In certain implementations, the first machine learning model 420 can be trained jointly with other components in a structure-from-motion pipeline, using multi-view correspondences to provide supervision even when explicit ground truth position values are not available, as explained further below.

In certain implementations, the first machine learning model 420 may specifically correspond to the camera 404. For example, the first machine learning model 420 may be trained to estimate the intrinsic parameters of the camera 404, the extrinsic parameters of the camera 404, or a combination thereof. Intrinsic parameters of the camera 404 may include internal characteristics that define how the camera 404 captures images, including properties such as focal length, principal point coordinates, skew coefficient, and lens distortion coefficients. Extrinsic parameters may include the position and orientation (pose) of the camera 404 (such as in a global coordinate system). The first machine learning model 420 may be trained to account for the intrinsic and extrinsic parameters by learning the mapping from distorted image coordinates to undistorted position values 410 that represent the true spatial directions or locations of points in the scene. During training, the model 420 may receive input image coordinates affected by the camera 404's intrinsic properties, such as lens distortions, and learn to output position values that correspond to an idealized pinhole camera model or another standardized representation.

In certain implementations, after the first machine learning model 420 has been trained to learn the first projection function, the camera 404's intrinsic parameters can be estimated by fitting the learned function to a predefined mathematical camera model. This involves minimizing the difference between the position values 410 predicted by the first machine learning model 420 and those computed from the first projection equations (e.g., unprojection equations) of a standard camera model with unknown parameters. An optimization process may adjust the intrinsic parameters, such as focal length, principal point coordinates, and distortion coefficients, to best align the outputs of the mathematical camera model with those of the trained first machine learning model 420, and thereby determine estimated parameters for the camera 404.

In certain implementations, to project the position values 410 (such as direction vectors) back onto the image 406 coordinates, a second projection function may be necessary. This second projection function may be defined as the inverse of the first projection function implemented by the first machine learning model 420. For example, while the first projection function map image coordinates to position values in three-dimensional space, the second projection function may map position values onto image coordinates (such as the two-dimensional image plane of the image 406). This function may be referred to as the “projection function,” “forward projection function,” or “3D-to-2D mapping function.”

In certain implementations, various techniques may be used to determine the second projection function. One approach is to invert the first machine learning model 420, where the first machine learning model 420 is invertible. For example, the first machine learning model 420 may be an invertible multi-layer perceptron (MLP) model. An invertible multilayer perceptron (MLP) model may include a neural network architecture designed such that each layer is invertible, and the overall mapping from inputs to outputs can be reversed to recover the inputs from the outputs. This may be achieved by using specific activation functions and layer constructions that preserve information and maintain a bijective relationship between input and output spaces.

In certain implementations, querying the model 420 individually for each pixel to compute the second projection function can be computationally intensive, especially for high-resolution images or real-time applications. Such processing may consume significant computing resources and increase processing time. Accordingly, techniques may be used to optimize the use of the model 420, such as through sampling. Furthermore, in certain implementations, the model 420 may not be invertible, and sampling techniques may be required to determine the second projection function. One approach may include coarse to fine projection to iteratively improve the accuracy of estimates determined based on the first machine learning model 420.

In particular, in certain implementations, determining, with the first machine learning model 420, the plurality of position values 410 may include determining, with a first machine learning model 420, a first set of position values 424 for a second subset 416 of the pixels. In such instances, for each respective pixel 408 of at least the first subset 414 of the pixels, the computing device 402 may be configured to determine a first position value 428 based on the first set of position values 424 and the respective pixel 408, such as using the model 420.

In certain implementations, various strategies can be employed to select the second subset 416 of pixels. For example, the computing device 402 may be configured to select pixels that provide even coverage across the image 406, forming a regular grid pattern. Alternatively, the second subset 416 of pixels may be selected based on areas of interest, such as regions with high texture detail, edges, or anticipated motion, resulting in a clustered selection. Adaptive strategies might involve selecting more pixels in regions where rapid changes in position values occur, using techniques like variance-based sampling. Variable spacing can also be applied, with denser sampling near the center of the image 406 and sparser sampling toward the edges, depending on lens characteristics like radial distortion.

In certain implementations, determining the first set of position values 424 may include querying the first machine learning model 420 for the second subset 416 of the pixels and storing the received values in a lookup table. To generate the initial lookup table, the computing device 402 may be configured to query the first machine learning model 420 using the second subset 416 of pixels, which may be a sparser set of pixels (such as with fewer total pixels) than the first subset 414. For each pixel in the second subset 416, the corresponding position value 424 may be determined by the first machine learning model 420. These position values 424 may serve as keys in the lookup table, while the associated image coordinates of the pixels in the second subset 416 may serve as values. The lookup table thus contains key-value pairs linking position values to image coordinates, which may represent a coarse mapping of the first projection function. When determining the first position value 428 for other pixels, the computing device 402 may then reference this lookup table and to determine position values.

In certain implementations, the computing device 402 may be configured to use interpolation to estimate position values (such as determining the first position value 428) for pixels not included in the second subset 416. In particular, determining the first position value 428 may include determining a distance measure 432 between the respective pixel 408 and the second subset 416 of pixels, determining two or more pixels from the second subset 416 of pixels with the smallest distance measure 432, and determining the first position value 428 by interpolating between corresponding position values for the two or more pixels.

In certain such implementations, determining the first position value 428 may include calculating a distance measure 432 between the respective pixel 408 and the pixels in the second subset 416, determining appropriate interpolation weights based on these distance measures, and computing the first position value 428 as an interpolation of the corresponding position values 424. In certain implementations, the computing device 402 may compute the distance measure 432 using the cosine similarity between the direction vector associated with the respective pixel 408 and the direction vectors (position values 424) stored in the lookup table for the second subset 416 of pixels. To compute the interpolation weights, the computing device 402 may apply a softmax function to the scaled cosine similarities, effectively normalizing them into probabilities that sum to one. In such instances, the weights may be computed as:

$${ω}_{i} = \frac{exp ( \frac{s \cdot {s}_{i}}{t} )}{{\sum }_{k} exp ( \frac{s \cdot {s}_{k}}{t} )}$$

where s is the direction vector for the respective pixel 408, sᵢ are corresponding position values 424 (e.g., direction vectors) from the lookup table, and t is a temperature parameter controlling the sharpness of the distribution.

Once the weights are computed, the first position value 428 may be determined by taking a weighted sum of the corresponding image coordinates (from the second subset 416) using these weights: x=Σₓᵢ wᵢxᵢ, where x is the estimated image coordinate for the respective pixel 408, and xi are the image coordinates associated with the direction vectors in the lookup table.

In certain implementations, determining the respective position value for the respective pixel 408 may further include determining, with the first machine learning model 420, a second set of position values 426 for a third subset 418 of the pixels, the third subset 418 of the pixels are located near the respective pixel 408, determining a second position value 430 based on the second set of position values 426 and the respective pixel 408, and determining the respective position for the respective value based on the second position value 430. In certain implementations, the third subset 418 of pixels may be selected to include pixels that are within a predetermined threshold distance of the respective pixel 408 in the image 406, such as according to one or more of the distance measures discussed above. Additionally, the third subset 418 of pixels may be selected according to one or more pixel selection strategies discussed above. Similar to the first set of position values 424, to improve the accuracy of the position value estimation for the respective pixel 408, the computing device 402 may be configured to determine a second set of position values 426 by querying the first machine learning model 420 at the third subset 418 of pixel locations. Because the third subset of pixels are closer to the respective pixel 408, the second set of position values 426 may provide a more accurate estimate of the respective position value.

In certain implementations, the process of refining the position value estimation can be repeated iteratively to achieve greater accuracy. Each iteration may include querying additional points closer to the respective pixel 408 or reducing the threshold distance to focus on an even smaller neighborhood. This coarse-to-fine approach allows the computing device 402 to progressively improve the precision of the position values, potentially achieving sub-pixel accuracy in projecting the 3D points.

The computing device 402 may be configured to train a second machine learning model 422 based on the determined position values. In certain implementations, the computing device 402 may utilize the determined position values 410 to train a second machine learning model 422, such as a depth estimation network. By incorporating the general camera 404 model learned by the first machine learning model 420, these techniques enable the simultaneous learning of both the unprojection function and depth estimation within a unified framework.

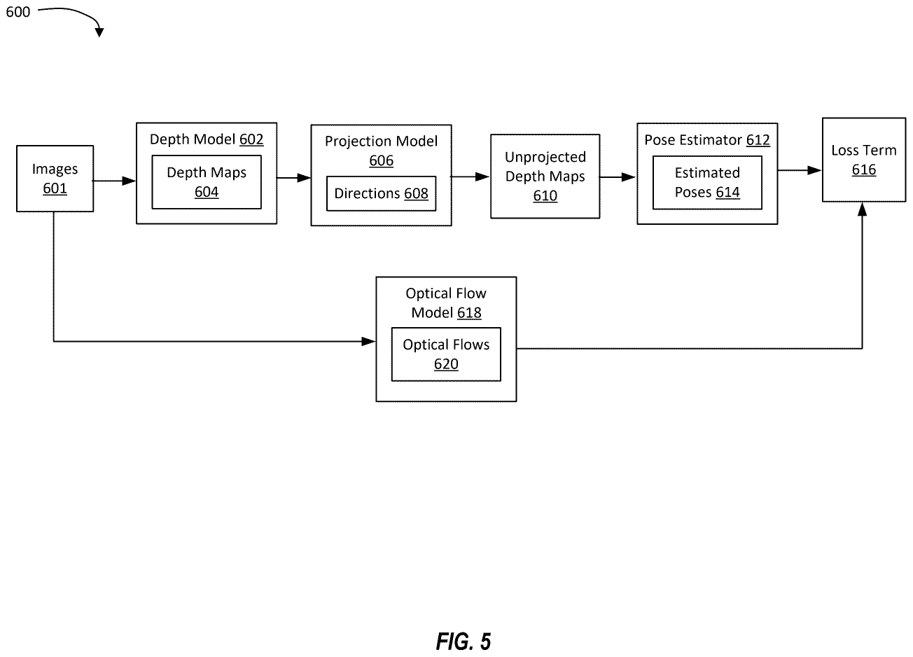

In certain implementations, the first machine learning model 420 and the second machine learning model 422 can be trained jointly within an SfM pipeline. During this process, the models 420, 422 may leverage multi-view correspondences for supervision. Images 406 captured from different viewpoints provide overlapping observations of the scene, allowing the models to learn consistent mappings between image coordinates, position values, and depths across views. The joint training may enable compatibility between the models 420, 422, accommodating the intrinsic and extrinsic parameters of the camera 404 and accounting for scene geometry and motion. Additional details are discussed below in connection with FIG. 5.

In certain implementations, when integrated into the SfM pipeline, these techniques can be extended to incorporate motion parametrization methods. By modeling motion in the scene using a continuous low-dimensional representation of motion trajectories, the system 400 may account for dynamic elements and moving objects. The computing device 402 may learn a set of basis motion trajectories shared across all points in the scene. A separate machine learning model may predict per-pixel weights that determine how each point moves according to these basis trajectories over time. This approach allows for the joint estimation of scene geometry, camera 404 parameters, and object motion within a unified framework.

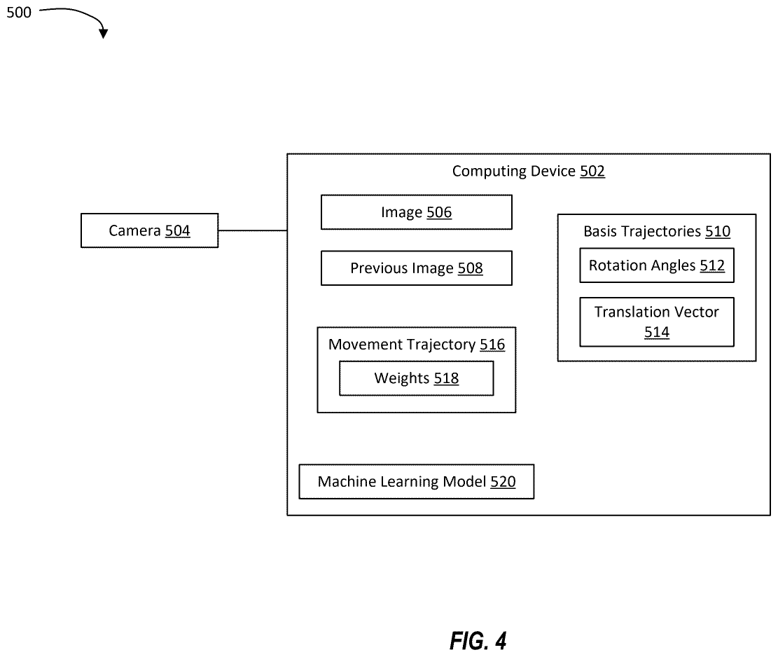

For instance, FIG. 4 is a block diagram illustrating a system 500 for determining parametrized motion representations according to one aspect of the present disclosure. The system 500 may be an exemplary implementation of the processing system 500. As noted above, machine learning processors (such as the machine learning processor 120) may be implemented as one or more of a neural processor, a hardware-based machine learning accelerator, a machine learning core within a CPU, an NSP, an NPU, and the like. The system 500 includes a camera 504 and a computing device 502. The computing device 502 includes a first image 506, a previous image 508, a basis trajectories 510, a movement trajectory 516, and a third machine learning model 520. The basis trajectories 510 includes rotation angles 512 and a translation vector 514. The movement trajectory 516 includes weights 518. In certain implementations, the system 500 may be an exemplary implementation of the system 400. For example, the camera 504 may be an exemplary implementation of the camera 404, the computing device 502 may be an exemplary implementation of the computing device 402, or a combination thereof.

The computing device 502 may be configured to receive a first image 506 of a scene captured by a camera 504. In certain implementations, the computing device 502 may receive the first image 506 of the scene captured by the camera 504 via a wired or wireless connection. The image 506 may be in formats such as RAW, JPEG, or PNG, and the camera 504 may be any type of image-capturing device, including monocular, stereo, fisheye, or wide-angle cameras.

The computing device 502 may be configured to determine positions for pixels of the first image 506 relative to the camera 504. In certain implementations, the positions for the pixels are determined by a machine learning model trained to use a generalized camera 504 projection (such as the first machine learning model 420 above).

The computing device 502 may be configured to determine basis trajectories 510 based on movement of the positions relative to at least one previous image 508 frame. In certain implementations, the basis trajectories 510 may define different rigid body motions, representing fundamental movements that an object or the camera 504 can undergo without deformation. A rigid body motion may refer to the movement of an object where the distances between all points within the object remain constant throughout the motion, undergoing transformations such as rotation and translation in three-dimensional space, without changing its shape or size.

Accordingly, in certain implementations, the basis trajectories 510 may identify rotation and translation of a point or object. In particular implementations, the basis trajectories 510 may include three rotation angles 512 and a three-dimensional translation vector 514. In certain implementations, the basis trajectories 510 can be stored as a set of parameters representing the rotational and translational components of motion. The rotation angles 512 may be represented using Euler angles, which include three angles corresponding to rotations around the x, y, and z axes (often referred to as roll, pitch, and yaw). Alternatively, quaternions or rotation matrices can be used for representing rotations.

In certain implementations, the basis trajectories 510 are learned separately for each frame by the computing device 502. Specifically, at each time step corresponding to a frame (such as the first image 506), the computing device 502 (such as the model 520) learns a set of basis trajectories 510 that capture the potential motions within the scene during that frame. These basis trajectories 510 may optimized as free parameters during a training process to best represent a observed motion between frames.

The learning process may include adjusting the basis trajectories 510 to minimize a loss function that measures discrepancies between the predicted and actual pixel positions across frames. During training, the model 520 compares data from pairs of images (such as the first image 506 and the previous image 508) to understand how pixels move from one frame to the next.

The computing device 502 may be configured to determine, for each of at least a subset of the pixels, a movement trajectory 516 relative to the at least one previous image 508 frame as a weighted combination of the basis trajectories 510. In certain implementations, the movement trajectory 516 may be determined as a weighted linear combination of the basis trajectories 510. In certain implementations, for each pixel, the computing device 502 may be configured to calculate movement of the pixel between frames by combining the predefined basis trajectories 510 using specific weights 518. In such instances, the movement trajectory 516 may then be determined as:

$${T}_{i} = \begin{matrix}\begin{matrix}B \\ \sum \end{matrix} \\ b = 1\end{matrix} {w}_{i}^{( b )} ( x ) {T}_{i}^{( b )} ,$$

where Ti(x) is the movement trajectory for pixel x at time i, wi(b)(x) are the weights assigned to each basis trajectory Ti(b), and B is the number of basis trajectories.

In certain implementations, the movement trajectories are determined by a third machine learning model 520 that may be trained to determine the weights 518 based on the positions for pixels of the first image 506 and previous positions for pixels of the at least one previous image 508 frame. In certain implementations, the third machine learning model 520 may be a multi-layer perceptron model. In particular implementations, the third machine learning model 520 may receive as input the three-dimensional positions of pixels (such as obtained from the positions determined by the second machine learning model 420) and temporal information, such as the frame index or timestamp. The model 520 may learn to output the weights 518 that specify how much each basis trajectory 510 contributes to the movement of each pixel between consecutive frames.

Training of the third machine learning model 520 involves using a dataset consisting of pairs of images (first image 506 and previous image 508) with known pixel correspondences and motion information. The model 520 may be optimized to minimize a loss function that measures the difference between the predicted movement trajectories and the ground truth motions, allowing it to learn the underlying motion patterns in the scene.

In certain implementations, these techniques may be performed as part of an SfM pipeline configured to estimate multi-view 3D geometry, camera poses, camera intrinsics, per-pixel object motion, or a combination thereof. In particular, the movement trajectories 516 determined for each pixel may be applied recursively to update the positions of the pixels across successive frames. By sequentially transforming the pixel positions using the weighted combinations of the basis trajectories 510, the method captures the cumulative effect of motion over time. This approach enables the tracking of moving objects through the scene and allows for the estimation of their trajectories across multiple frames, allowing the computing device 502 to reconstruct the paths of moving objects throughout the duration of a sequence, including scenes where multiple objects are moving independently.

FIG. 5 depicts a schematic diagram of a training process 600 according to one aspect of the present disclosure. The training process 600 may be performed to provide supervised training within a structure-from-motion pipeline. For example, the process 600 may be performed using one or more components of the systems 400, 500. The system 600 includes a depth model 602, a projection model 606, an unprojected depth maps module 610, a pose estimator 612, a loss computation module 616, and an optical flow model 618.

The depth model 602 may be a neural network configured to estimate depth maps 604 from input images captured by the camera 404 or 504. Specifically, the depth model 602 receives images and generates per-pixel depth predictions, producing depth maps 604 that represent the estimated distance from the camera to points in the scene at each pixel. The depth model 602 may employ architectures such as encoder-decoder convolutional neural networks with layers designed to capture both global context and fine-grained details of the scene.

The projection model 606 may be an exemplary implementation of the first machine learning model 420, as described earlier. It may be configured to approximate the generalized unprojection function, mapping image coordinates to direction vectors 608 representing the viewing rays corresponding to each pixel. The direction vectors 608 capture the spatial relationship between image pixels and their corresponding directions in three-dimensional space relative to the camera. The projection model 606 may be implemented as a multilayer perceptron (MLP) that outputs unit direction vectors based on input pixel coordinates, potentially expressed in polar coordinates for radially symmetric cameras.

The unprojected depth maps 610 may be determined by combining the depth maps 604 from the depth model 602 with the direction vectors 608 from the projection model 606 to produce unprojected depth maps 610. This process may include converting the per-pixel depth estimates into three-dimensional point clouds by associating each depth value with its corresponding direction vector.

The pose estimator 612 may be configured to estimate the camera poses 614 (extrinsic parameters) for each frame by aligning the unprojected depth maps 610 from different views. The pose estimator 612 may compute the relative transformations between the camera positions at different times, determining rotations and translations that best align the point clouds from consecutive frames. In certain implementations, the pose estimator 612 may be configured to use an orthogonal Procrustes process, which solves for the rotation and translation that minimize the mean squared error between two sets of corresponding 3D points.

For frames iᵢ and jⱼ, the pose estimator 612 may be configured to determine the transformation EᵢⱼEᵢⱼ that aligns the unprojected point cloud XᵢXᵢ from frame iᵢ to the point cloud XⱼXⱼ from frame jⱼ. The estimated poses 614 enable the system to understand the camera's movement through the environment.

A loss term 616 may be determined and used to supervise the training of the depth model 602 and the projection model 606. The loss term 616 may be based on the discrepancy between the predicted pixel correspondences, derived from the estimated depths and poses, and the observed correspondences obtained from the optical flows 620 generated by the optical flow model 618. The loss term 616 may include a reprojection loss term, a weighted ordinal depth loss term, a rays loss term, or a combination thereof.

The optical flow model 618 is configured to determine optical flows 620 between frames, providing the observed pixel correspondences used in the loss computation. The optical flow model 618 may utilize advanced neural networks such as RAFT (Recurrent All-Pairs Field Transforms) or other processes to estimate dense optical flow fields. The optical flows 620 represent the per-pixel motion vectors from one frame to the next and serve as ground truth or supervisory signals for training the pipeline.

In the training process 600, the depth model 602 processes input images and generates depth maps 604, providing per-pixel depth estimates for each frame. Concurrently, the projection model 606 maps image coordinates to direction vectors 608, implementing the unprojection function discussed above. The unprojected depth maps 610 may be formed by combining the depth maps 604 with the direction vectors 608, resulting in 3D point clouds X(u) representing the scene geometry in the camera coordinate system.

The pose estimator 612 aligns the unprojected depth maps 610 from multiple frames, estimating the camera poses 614 by solving for the rotations and translations that best align the 3D point clouds. In certain implementations, the pose estimator 612 may be configured to use an orthogonal Procrustes process to align the 3D point clouds, which determines the rotation and translation that minimize the mean squared error between two sets of corresponding 3D points.

During the backward pass, the gradients of the loss term 616 with respect to the parameters of the depth model 602 and the projection model 606 are computed through backpropagation. Optimization algorithms, such as stochastic gradient descent (SGD), are used to update the model parameters, aiming to minimize the loss over the training data.

The training process is repeated over multiple iterations or epochs, using various image pairs or sequences from the dataset. By continuously refining the models through this iterative training, the system 600 enhances the overall accuracy of 3D reconstruction. The integration of the depth model 602, projection model 606, pose estimator 612, and optical flow model 618 within the supervised training process allows the computing device to learn accurate representations of the scene's geometry and camera movements.

In implementations where motion parametrization techniques are included, as detailed previously, the system 600 may incorporate additional components to handle dynamic scenes. For example, a third machine learning model 520 may predict per-pixel weights 518 for a set of basis trajectories 510, modeling the motion of dynamic objects in the scene. These weights 518 may be used to compute movement trajectories 516 for each pixel, capturing complex motions as weighted combinations of simple rigid body motions represented by the basis trajectories 510.

In such instances, the loss term 616 may be determined to include a motion-weighted ordinal depth loss to address areas with significant motion. In regions where the predicted motion transformations are large, which may indicate moving objects, the reliance on multi-view geometric constraints may be reduced. By incorporating motion parametrization into the training process, the training process 600 may be able to jointly model camera motion, object motion, and scene geometry within a unified framework, enhancing the accuracy of reconstruction and camera parameter estimation in dynamic environments.

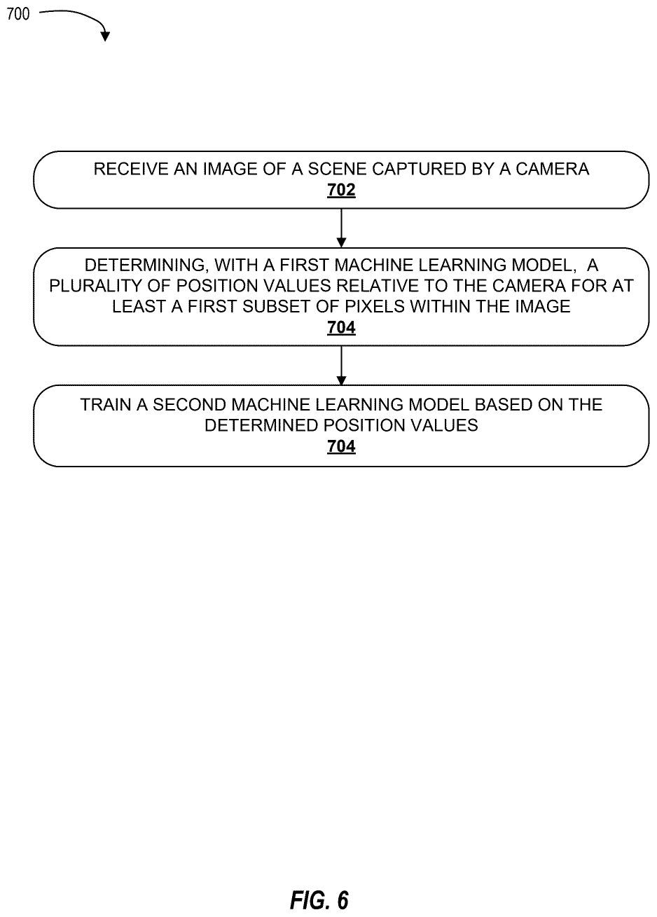

FIG. 6 is a flow chart illustrating an example method 700 for determining generalized camera models according to one or more aspects of the present disclosure. The method may be performed by one or more of the above systems, such as the systems 100, 200, 400, 500, 600.

The method 700 includes receiving an image of a scene captured by a camera (block 702). For example, the computing device 402 may receive an image 406 of a scene captured by a camera 404.

The method 700 includes determining, with a first machine learning model, a plurality of position values relative to the camera for at least a first subset of pixels within the image (block 704). For example, the computing device 402 may determine, with a first machine learning model 420, a plurality of position values 410 relative to the camera 404 for at least a first subset 414 of pixels within the image 406. In certain implementations, the first machine learning model 420 may be trained specific to the intrinsic parameters of the camera 404, the extrinsic parameters of the camera 404, or a combination thereof. In certain implementations, the first machine learning model 420 may be trained to implement a first projection function that maps image 406 coordinates to corresponding position values. In certain implementations, the first machine learning model 420 may be a neural network comprising a multilayer perceptron (MLP).

In certain implementations, determining, with the first machine learning model 420, the plurality of position values 410 includes, for each respective pixel 408 of at least the first subset 414 of the pixels, determining, with a first machine learning model 420, a first set of position values 424 for a second subset 416 of the pixels, determining a first position value 428 based on the first set of position values 424 and the respective pixel 408, and determining a respective position for the respective pixel 408 based on the first position value 428. In certain implementations, determining the first set of position values 424 includes querying the first machine learning model 420 for the second subset 416 of the pixels and storing the received values in a lookup table. In certain implementations, the second subset 416 of the pixels has fewer pixels than the first subset 414 of the pixels.

In certain implementations, determining the first position value 428 includes determining a distance measure 432 between the respective pixel 408 and the second subset 416 of pixels, determining two or more pixels from the second subset 416 of pixels with the smallest distance measure 432, and determining the first position value 428 by interpolating between corresponding position values for the two or more pixels.

In certain implementations, determining the respective position for the respective pixel 408 includes determining, with the first machine learning model 420, a second set of position values 426 for a third subset 418 of the pixels, where the third subset 418 of the pixels are located near the respective pixel 408, determining a second position value 430 based on the second set of position values 426 and the respective pixel 408, and determining the respective position for the respective value based on the second position value 430.

The method 700 includes training a second machine learning model based on the determined position values (block 706). For example, the computing device 402 may train a second machine learning model 422 based on the determined position values.

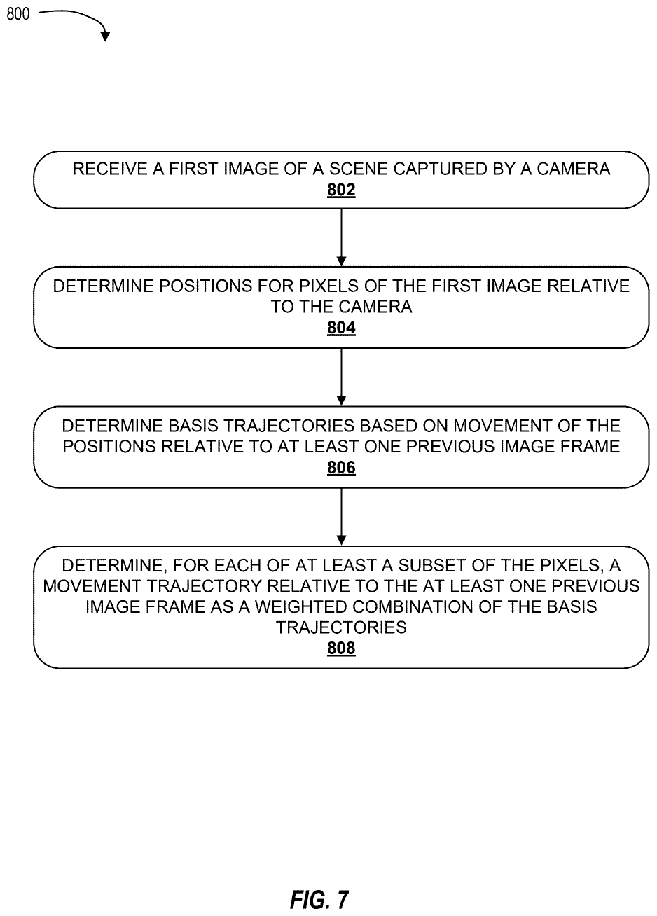

FIG. 7 is a flow chart illustrating an example method 800 for determining parametrized motion representations according to one or more aspects of the present disclosure. The method may be performed by one or more of the above systems, such as the systems 100, 200, 400, 500, 600.

The method 800 includes receiving a first image of a scene captured by a camera (block 802). For example, the computing device 502 may receive a first image 506 of a scene captured by a camera 504.

The method 800 includes determining positions for pixels of the first image relative to the camera (block 804). For example, the computing device 502 may determine positions for pixels of the first image 506 relative to the camera 504. In certain implementations, the positions for the pixels are determined by a machine learning model 420 trained to use a generalized camera 504 projection.

The method 800 includes determining basis trajectories based on movement of the positions relative to at least one previous image frame (block 806). For example, the computing device 502 may determine basis trajectories 510 based on movement of the positions relative to at least one previous image 508 frame. In certain implementations, the basis trajectories 510 identify rotation and translation of a pixel. In certain implementations, the basis trajectories 510 include three rotation angles 512 and a three-dimensional translation vector 514.

The method 800 includes determining, for each of at least a subset of the pixels, a movement trajectory relative to the at least one previous image frame as a weighted combination of the basis trajectories (block 808). For example, the computing device 502 may determine, for each of at least a subset of the pixels, a movement trajectory 516 relative to the at least one previous image 508 frame as a weighted combination of the basis trajectories 510. In certain implementations, the movement trajectory 516 may be determined as a weighted linear combination of the basis trajectories 510. In certain implementations, the movement trajectories are determined by a third machine learning model 520 that may be trained to determine the weights 518 based on the positions for pixels of the first image 506 and previous positions for pixels of the at least one previous image 508 frame. In certain implementations, the third machine learning model 520 may be a multi-layer perceptron model. In certain implementations, the method may be performed as part of a structure from motion pipeline configured to estimate multi-view 3D geometry, camera poses, camera intrinsics, per-pixel object motion, or a combination thereof.

It is noted that one or more blocks (or operations) described with reference to FIG. 4 may be combined with one or more blocks (or operations) described with reference to another of the figures. For example, one or more blocks (or operations) of FIG. 4 may be combined with one or more blocks (or operations) of FIG. 1-3.

In one or more aspects, the above-described techniques may include additional aspects, such as any single aspect or any combination of aspects described below or in connection with one or more other processes or devices described elsewhere herein.

A first aspect provides a method that includes receiving an image of a scene captured by a camera; determining, with a first machine learning model, a plurality of position values relative to the camera for at least a first subset of pixels within the image; and training a second machine learning model based on the determined position values.

In a second aspect according to the first aspect, the first machine learning model is trained to implement a first projection function that maps image coordinates to corresponding position values.

In a third aspect according to the second aspect, the first machine learning model is an invertible multi-layer perceptron (MLP) model.

In a fourth aspect according to the first aspect, determining, with the first machine learning model, the plurality of position values includes, for each respective pixel of at least the first subset of the pixels, determining, with the first machine learning model, a first set of position values for a second subset of the pixels; determining a first position value based on the first set of position values and the respective pixel; and determining a respective position for the respective pixel based on the first position value.

In a fifth aspect according to the fourth aspect, determining the first set of position values includes querying the first machine learning model for the second subset of the pixels and storing the received values in a lookup table.

In a sixth aspect according to the fourth aspect, the second subset of the pixels has fewer pixels than the first subset of the pixels.

In a seventh aspect according to the fourth aspect, determining the first position value includes determining a distance measure between the respective pixel and the second subset of pixels; determining two or more pixels from the second subset of pixels with the smallest distance measure; and determining the first position value by interpolating between corresponding position values for the two or more pixels.

In an eighth aspect according to the fourth aspect, determining the respective position for the respective pixel includes determining, with the first machine learning model, a second set of position values for a third subset of the pixels, wherein the third subset of the pixels are located near the respective pixel; determining a second position value based on the second set of position values and the respective pixel; and determining the respective position for the respective pixel based on the second position value.

A ninth aspect, in combination with any of the first through eighth aspects, provides that the first machine learning model is trained specific to the intrinsic parameters of the camera, the extrinsic parameters of the camera, or a combination thereof.

A tenth aspect provides a system that includes a processor and a memory storing instructions which, when executed by the processor, cause the processor to perform operations including receiving an image of a scene captured by a camera; determining, with a first machine learning model, a plurality of position values relative to the camera for at least a first subset of pixels within the image; and training a second machine learning model based on the determined position values.

In an eleventh aspect according to the tenth aspect, the first machine learning model is trained to implement a first projection function that maps image coordinates to corresponding position values.

In a twelfth aspect according to any of the tenth and eleventh aspects, the first machine learning model is an invertible multi-layer perceptron (MLP) model.

In a thirteenth aspect according to any of the tenth through twelfth aspects, the operations of determining, with the first machine learning model, the plurality of position values include, for each respective pixel of at least the first subset of the pixels, determining, with the first machine learning model, a first set of position values for a second subset of the pixels; determining a first position value based on the first set of position values and the respective pixel; and determining a respective position for the respective pixel based on the first position value.

In a fourteenth aspect according to any of the tenth through thirteenth aspects, determining the first set of position values includes querying the first machine learning model for the second subset of the pixels and storing the received values in a lookup table.

In a fifteenth aspect according to any of the tenth through fourteenth aspects, the second subset of the pixels has fewer pixels than the first subset of the pixels.

In a sixteenth aspect according to any of the tenth through fifteenth aspects, determining the first position value includes determining a distance measure between the respective pixel and the second subset of pixels; determining two or more pixels from the second subset of pixels with the smallest distance measure; and determining the first position value by interpolating between corresponding position values for the two or more pixels.

In a seventeenth aspect according to any of the tenth through sixteenth aspects, determining the respective position for the respective pixel includes determining, with the first machine learning model, a second set of position values for a third subset of the pixels, wherein the third subset of the pixels are located near the respective pixel; determining a second position value based on the second set of position values and the respective pixel; and determining the respective position for the respective pixel based on the second position value.

In an eighteenth aspect according to any of the tenth through seventeenth aspects, the first machine learning model is trained specific to the intrinsic parameters of the camera, the extrinsic parameters of the camera, or a combination thereof.

A nineteenth aspect provides a non-transitory computer-readable medium storing instructions which, when executed by a processor, cause the processor to perform operations that includes receiving an image of a scene captured by a camera; determining, with a first machine learning model, a plurality of position values relative to the camera for at least a first subset of pixels within the image; and training a second machine learning model based on the determined position values.

In a twentieth aspect according to the nineteenth aspect, the first machine learning model is trained to implement a first projection function that maps image coordinates to corresponding position values.

In a twenty-first aspect according to any of the nineteenth and twentieth aspects, the first machine learning model is an invertible multi-layer perceptron (MLP) model.

In a twenty-second aspect according to any of the nineteenth through twenty-first aspects, the operations of determining, with the first machine learning model, the plurality of position values include, for each respective pixel of at least the first subset of the pixels, determining, with the first machine learning model, a first set of position values for a second subset of the pixels; determining a first position value based on the first set of position values and the respective pixel; and determining a respective position for the respective pixel based on the first position value.

In a twenty-third aspect according to any of the nineteenth through twenty-second aspects, determining the first set of position values includes querying the first machine learning model for the second subset of the pixels and storing the received values in a lookup table.

In a twenty-fourth aspect according to any of the nineteenth through twenty-third aspects, the second subset of the pixels has fewer pixels than the first subset of the pixels.

In a twenty-fifth aspect according to any of the nineteenth through twenty-fourth aspects, determining the first position value includes determining a distance measure between the respective pixel and the second subset of pixels; determining two or more pixels from the second subset of pixels with the smallest distance measure; and determining the first position value by interpolating between corresponding position values for the two or more pixels.

In a twenty-sixth aspect according to any of the nineteenth through twenty-fifth aspects, determining the respective position for the respective pixel includes determining, with the first machine learning model, a second set of position values for a third subset of the pixels, wherein the third subset of the pixels are located near the respective pixel; determining a second position value based on the second set of position values and the respective pixel; and determining the respective position for the respective pixel based on the second position value.

In a twenty-seventh aspect according to any of the nineteenth through twenty-sixth aspects, the first machine learning model is trained specific to the intrinsic parameters of the camera, the extrinsic parameters of the camera, or a combination thereof.

A twenty-eighth aspect provides a method that includes receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

In a twenty-ninth aspect according to the twenty-eighth aspect, the basis trajectories indicate rigid body motion.

In a thirtieth aspect according to any of the twenty-eighth and twenty-ninth aspects, the basis trajectories include three rotation angles and a three-dimensional translation vector.

In a thirty-first aspect according to any of the twenty-eighth through thirtieth aspects, the movement trajectory is determined as a weighted linear combination of the basis trajectories.

In a thirty-second aspect according to any of the twenty-eighth through thirty-first aspects, the movement trajectories are determined by a third machine learning model that is trained to determine the weights based on the positions for pixels of the first image and previous positions for pixels of the at least one previous image frame.

In a thirty-third aspect according to any of the twenty-eighth through thirty-second aspects, the third machine learning model is a multi-layer perceptron (MLP) model.

In a thirty-fourth aspect according to any of the twenty-eighth through thirty-third aspects, the method is performed as part of a structure from motion pipeline configured to estimate multi-view 3D geometry, camera poses, camera intrinsics, per-pixel object motion, or a combination thereof.

A thirty-fifth aspect provides a system that includes a processor and a memory storing instructions which, when executed by the processor, cause the processor to perform operations including receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

In a thirty-sixth aspect according to the thirty-fifth aspect, the basis trajectories indicate rigid body motion.

In a thirty-seventh aspect according to any of the thirty-fifth and thirty-sixth aspects, the basis trajectories include three rotation angles and a three-dimensional translation vector.

In a thirty-eighth aspect according to any of the thirty-fifth through thirty-seventh aspects, the movement trajectory is determined as a weighted linear combination of the basis trajectories.

In a thirty-ninth aspect according to any of the thirty-fifth through thirty-eighth aspects, the movement trajectories are determined by a third machine learning model that is trained to determine the weights based on the positions for pixels of the first image and previous positions for pixels of the at least one previous image frame.

In a fortieth aspect according to any of the thirty-fifth through thirty-ninth aspects, the third machine learning model is a multi-layer perceptron (MLP) model.

In a forty-first aspect according to any of the thirty-fifth through fortieth aspects, the operations are performed as part of a structure from motion pipeline configured to estimate multi-view 3D geometry, camera poses, camera intrinsics, per-pixel object motion, or a combination thereof.

A forty-second aspect provides a non-transitory computer-readable medium storing instructions which, when executed by a processor, cause the processor to perform operations that includes receiving a first image of a scene captured by a camera; determining positions for pixels of the first image relative to the camera; determining basis trajectories based on movement of the positions relative to at least one previous image frame; and determining, for each of at least a subset of the pixels, a movement trajectory relative to the at least one previous image frame as a weighted combination of the basis trajectories.

In a forty-third aspect according to the forty-second aspect, the basis trajectories indicate rigid body motion.

In a forty-fourth aspect according to any of the forty-second and forty-third aspects, the basis trajectories include three rotation angles and a three-dimensional translation vector.

In a forty-fifth aspect according to any of the forty-second through forty-fourth aspects, the movement trajectory is determined as a weighted linear combination of the basis trajectories.

In a forty-sixth aspect according to any of the forty-second through forty-fifth aspects, the movement trajectories are determined by a third machine learning model that is trained to determine the weights based on the positions for pixels of the first image and previous positions for pixels of the at least one previous image frame.

In a forty-seventh aspect according to any of the forty-second through forty-sixth aspects, the third machine learning model is a multi-layer perceptron (MLP) model.

In a forty-eighth aspect according to any of the forty-second through forty-seventh aspects, the operations are performed as part of a structure from motion pipeline configured to estimate multi-view 3D geometry, camera poses, camera intrinsics, per-pixel object motion, or a combination thereof.

In some implementations, the systems described in the aspects above may include a wireless device, such as a UE. In some implementations, the system may include at least one processor, and a memory coupled to the processor. The processor may be configured to perform operations described herein with respect to the apparatus. In some other implementations, the system may include a non-transitory computer-readable medium having program code recorded thereon and the program code may be executable by a computer for causing the computer to perform operations described herein with reference to the system. In some implementations, the system may include one or more means configured to perform operations described herein. In some implementations, a method of wireless communication may include one or more operations described herein with reference to the system.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A system comprising:
a processor; and
a memory storing instructions which, when executed by the processor, cause the processor to perform operations including:
receiving a first image of a scene captured by a camera;
determining positions for pixels of the first image relative to the camera;
determining basis trajectories based on movement of the positions relative to at least one previous image frame; and
determining, for each of at least a subset of the pixels, a movement trajectory relative to the at least one previous image frame as a weighted combination of the basis trajectories.

2. The system of claim 1, wherein the basis trajectories indicate rigid body motion.

3. The system of claim 2, wherein the basis trajectories include three rotation angles and a three-dimensional translation vector.

4. The system of claim 1, wherein the movement trajectory is determined as a weighted linear combination of the basis trajectories.

5. The system of claim 1, wherein the movement trajectories are determined by a third machine learning model that is trained to determine the weights based on the positions for pixels of the first image and previous positions for pixels of the at least one previous image frame.

6. The system of claim 5, wherein the third machine learning model is a multi-layer perceptron (MLP) model.

7. A method comprising:
receiving a first image of a scene captured by a camera;
determining positions for pixels of the first image relative to the camera;
determining basis trajectories based on movement of the positions relative to at least one previous image frame; and
determining, for each of at least a subset of the pixels, a movement trajectory relative to the at least one previous image frame as a weighted combination of the basis trajectories.

8. The method of claim 7, wherein the basis trajectories indicate rigid body motion.

9. The method of claim 8, wherein the basis trajectories include three rotation angles and a three-dimensional translation vector.

10. The method of claim 7, wherein the movement trajectory is determined as a weighted linear combination of the basis trajectories.

11. The method of claim 7, wherein the movement trajectories are determined by a third machine learning model that is trained to determine the weights based on the positions for pixels of the first image and previous positions for pixels of the at least one previous image frame.

12. The method of claim 11, wherein the third machine learning model is a multi-layer perceptron (MLP) model.

13. A method comprising:
receiving an image of a scene captured by a camera;
determining, with a first machine learning model, a plurality of position values relative to the camera for at least a first subset of pixels within the image; and
training a second machine learning model based on the determined position values.

14. The method of claim 13, wherein the first machine learning model is trained to implement a first projection function that maps image coordinates to corresponding position values.

15. The method of claim 14, wherein the first machine learning model is an invertible multi-layer perceptron (MLP) model.

16. The method of claim 13, wherein determining, with the first machine learning model, the plurality of position values comprises, for each respective pixel of at least the first subset of the pixels:
determining, with the first machine learning model, a first set of position values for a second subset of the pixels;
determining a first position value based on the first set of position values and the respective pixel; and
determining a respective position for the respective pixel based on the first position value.

17. The method of claim 16, wherein determining the first set of position values comprises querying the first machine learning model for the second subset of the pixels and storing the received values in a lookup table.

18. The method of claim 16, wherein the second subset of the pixels has fewer pixels than the first subset of the pixels.

19. The method of claim 16, wherein determining the first position value comprises:
determining a distance measure between the respective pixel and the second subset of pixels;
determining two or more pixels from the second subset of pixels with the smallest distance measure; and
determining the first position value by interpolating between corresponding position values for the two or more pixels.

20. The method of claim 16, wherein determining the respective position for the respective pixel comprises:
determining, with the first machine learning model, a second set of position values for a third subset of the pixels, wherein the third subset of the pixels are located near the respective pixel;
determining a second position value based on the second set of position values and the respective pixel; and
determining the respective position for the respective pixel based on the second position value.
